(19) United States
(12) Patent Application Publication
(10) Pub. No.: US 2012/0120010 A1
(43) Pub. Date: May 17, 2012

(54) TOUCH APPARATUS

(76) Inventors: Ching-Hsiang YU, Taoyuan Hsien (TW); Fu-Mei HSU, Taoyuan Hsien (TW)

(21) Appl. No.: 13/267,588

(22) Filed: Oct. 6, 2011

(30) Foreign Application Priority Data
Nov. 15, 2010 (TW) 099139169

(51) Int. Cl. G08B 6/00; G06F 3/041

(52) U.S. Cl. 345/173

(57) ABSTRACT

The touch apparatus includes a casing, a touch module and at lease a non-rotary actuator. The touch module is disposed in the casing and at least has a touch panel. The non-rotary actuator is connected with the casing or the touch module. The touch apparatus can provide a good tactile feedback and make sound by the actuator.

### CROSS REFERENCE TO RELATED APPLICATIONS

This Non-provisional application claims priority under 35 U.S.C. §119(a) on Patent Application No(s). 099139169 filed in Taiwan, Republic of China on Nov. 15, 2010, the entire contents of which are hereby incorporated by reference.

### BACKGROUND OF THE INVENTION

1. Field of Invention

The present invention relates to a touch apparatus and, in particular, to a touch apparatus that can provide a good tactile feedback and make sound.

2. Related Art

Most of the electronic devices, such as the mobile phones, PDAs, computers, and GPSs, are configured with an input interface, which can be the conventional buttons or the novel touch interface. Although the touch interface can provide a more convenient operating way, it does not have the tactile feedback as the conventional mechanical buttons. Thus, the user must look at the screen of the electronic device to realize whether the button is pushed or not. In addition, if the response for the touch input carried out on the touch interface is slow, the user may erroneously judge that the previous touch input is not success and may repeat the touch input operation again. Accordingly, the vibration function for tactile feedback as well as the sound and the changes of the displayed content is added to the touch panel, so that the tactile and sound feedbacks while operating the touch interface can be similar to the operation of the conventional buttons.

FIG. 1 is a schematic diagram showing a conventional touch apparatus 1 with the tactile feedback, which is carried out by a mechanical rotary motor actuator 11. The mechanical rotary motor actuator 11 is disposed at one side of a frame body 13, which is used to fix the display panel 12, and is connected with the touch panel 14 and the casing 15. In general, the casing 15 is fixed on the touch panel 14 by screws. When the user touches the touch panel 14, the control circuit (not shown) immediately outputs a driving signal to control the mechanical rotary motor actuator 11 to operate so as to move the display panel 12, the touch panel 14 and the casing 15. Thus, it can simulate the tactile and sound feedbacks of the conventional mechanical buttons.

However, the mechanical rotary motor actuator 11 usually includes a rotor-unbalanced motor, which is driven by the driving signal, so the response speed thereof is slower. Thus, it can not properly simulate the tactile and sound feedbacks as the conventional mechanical buttons. In addition, the casing 15 is fixed to the touch panel 14 by the full thread screws, so that the touch panel 14 and the display panel 12 may not be fixed well if the screwing force is too weak. On the contrary, if the screwing force is too strong, the touch panel 14 may not provide good tactile and sound feedbacks.

### SUMMARY OF THE INVENTION

In view of the foregoing, an objective of the present invention is to provide a touch apparatus that can provide a good tactile feedback and make sound.

To achieve the above objective, the present invention discloses a touch apparatus including a casing, a touch module and at least one non-rotary actuator. The touch module is disposed in the casing and has at least one touch panel. The non-rotary actuator is connected with the casing or the touch module.

In addition, the touch apparatus further includes at least one buffer supporting unit, which is used to connecting the touch module and the casing. The buffer supporting unit includes a support element and a buffer element. The support element includes at least a screw-thread portion and at least a non-screw-thread portion, and the buffer element is disposed around the non-screw-thread portion. The length of the non-screw-thread portion is greater than the thickness of the casing. The buffer element can be a rubber washer or a spring.

The non-rotary actuator is a linear actuator such as a voice coil motor, which is composed of a permanent magnet and a field-magnet winding. In addition, the touch apparatus further includes a control circuit electrically connected with the non-rotary actuator, the control circuit outputs a driving signal to control the operation of the non-rotary actuator. The non-rotary actuator operates according to the waveform, cycle, frequency and amplitude of the driving signal, and the driving signal includes sound information. Alternative, the control circuit may receive a touch signal outputted from the touch panel and output a driving signal. Moreover, the touch module further includes at least one display panel and a frame body. The touch panel and the display panel are disposed in the frame body, and the non-rotary actuator is connected with the display panel through a frame. Thus, the control circuit can control the non-rotary actuator to operate so as to cause a vibration of the display panel.

To achieve the above objective, the present invention also discloses a touch apparatus including a casing, a touch module and at least a non-rotary actuator. The touch module is disposed in the casing and has at least a touch panel, at least a display panel, and a frame body. The touch panel and the display panel are disposed in the frame body, and the frame body is connected with the casing. The non-rotary actuator is connected with the touch panel, the display panel or the frame body.

In addition, the touch apparatus further includes at least one buffer supporting unit, which is used to connect the touch module and the casing or connect the touch panel and the frame body. The buffer supporting unit includes a support element and a buffer element. The support element includes at least a screw-thread portion and at least a non-screw-thread portion, and the buffer element is disposed around the non-screw-thread portion. The length of the non-screw-thread portion is greater than the thickness of the casing. The buffer element can be a rubber washer or a spring.

The non-rotary actuator is a linear actuator such as a voice coil motor, which is composed of a permanent magnet and a field-magnet winding. In addition, the touch apparatus further includes a control circuit electrically connected with the non-rotary actuator, the control circuit outputs a driving signal to control the operation of the non-rotary actuator. The non-rotary actuator operates according to the waveform, cycle, frequency and amplitude of the driving signal, and the driving signal includes sound information. Alternative, the control circuit may receive a touch signal outputted from the touch panel and output a driving signal. Moreover, the non-rotary actuator is connected with the display panel through a frame. Thus, the control circuit can control the non-rotary actuator to operate so as to cause a vibration of the display panel.

As mentioned above, the present invention adopts the non-rotary actuator such as a linear actuator, which is superior to the mechanical rotary motor actuator in the response speed. This is because the mechanical rotary motor actuator achieves the vibration according to its eccentric motion, so the staring speed and stopping time thereof are both slower. Thus, the mechanical rotary motor actuator can not be immediately started and stopped. On the contrary, the motion of the mass of the linear actuator is a linear motion, and it can move forward and backward based on the applied force. When the applied force disappears, the mass stops moving. Thus, the stopping time of the linear actuator is much shorter than that of the mechanical rotary motor actuator.

Accordingly, the touch apparatus of the invention has the non-rotary actuator, which is connected with the touch module, the touch panel, the display panel, the frame body, or the casing. When the user incurs a touch event on the touch module to drive the non-rotary actuator to operate, the touch module, the touch panel, the display panel, the frame body, or the casing, which is connected with the non-rotary actuator, is moved accordingly. Thus, the good tactile feedback can be provided. In addition, the non-rotary actuator can also vibrate the touch module, the touch panel, the display panel, the frame body, or the casing, which serves as a vibration membrane to make sound. In summary, the touch apparatus of the present invention can provide a good tactile feedback and make sound. To be noted, the present invention uses the casing or the touch module as the vibration membrane for making sound, which is different from the general speaker, so the sound holes of the casing are not necessary. Without configuring these sound holes, the touch apparatus of the present invention can provide a better water-proof property.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic diagram of a conventional touch apparatus;

FIG. 2A is a schematic diagram showing the cross-section of a touch apparatus according to a preferred embodiment of the present invention;

FIG. 2B is a schematic diagram showing the touch module and the linear actuator of FIG. 2A;

FIG. 2C is a schematic diagram showing the connection between the touch module and the casing of FIG. 2A;

FIG. 3A and FIG. 3B are schematic diagrams showing different aspects of the supporting element of the present invention;

FIG. 4A is a schematic diagram showing the cross-section of a touch apparatus of another aspect according to the preferred embodiment of the present invention; and

FIG. 4B is a schematic diagram showing the connection between the touch panel of the touch module and the linear actuator of FIG. 4A.

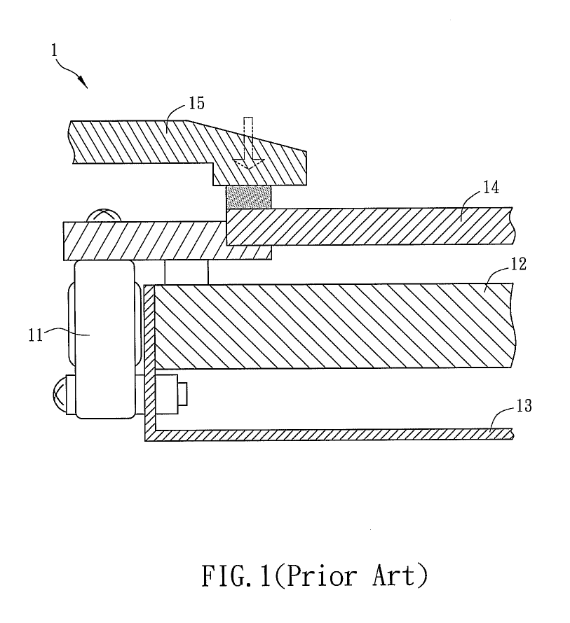

### DETAILED DESCRIPTION OF THE INVENTION

The present invention will be apparent from the following detailed description, which proceeds with reference to the accompanying drawings, wherein the same references relate to the same elements.

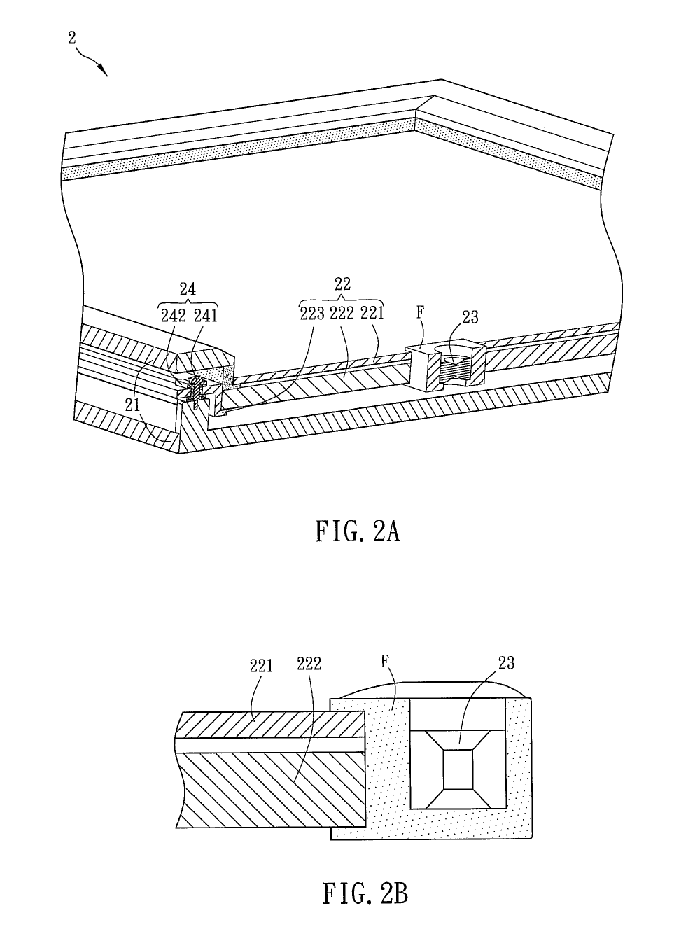

FIG. 2A is a schematic diagram showing the cross-section of a touch apparatus 2 according to a preferred embodiment of the present invention. With reference to FIG. 2A, the touch apparatus 2 includes a casing 21, a touch module 22 and at least one non-rotary actuator 23. The touch apparatus 2 can be a mobile phone, PDA, tablet computer, DVD player, monitor, or GPS. In this embodiment, the touch apparatus 2 is, for example but not limited to, a tablet computer.

The touch module 22 is disposed in the casing 21, and the casing 21 can be integrally formed as one piece or be formed by assembling several parts. In this embodiment, the touch module 22 includes at least one touch panel 221, at least one display panel 222 and a frame body 223. The touch panel 221 and the display panel 222 are disposed in the frame body 223. As shown in FIG. 2A, the display panel 222 is fixed in the frame body 223, and the touch panel 221 is disposed on the display panel 222. In addition, the frame body 223 is connected with the casing 21.

To be noted, in other aspects, the touch panel and the display panel can be integrated as a touch display panel. In order to make the touch apparatus 2 of the present invention more clear, the top part and bottom part of the casing 21 showing in the left of FIG. 2A seem to not connect with each other, but in practice, the top part and bottom part of the casing 21 are actually connected with each other. In additional aspects, the touch module 22 may be not configured with the frame body 223, and the touch module 22 is directly connected with the casing 21. In addition, the non-rotary actuator 23 may be connected with the casing 21. The configuration and connection between the casing, touch module and actuator are not limited in this invention.

FIG. 2B is a schematic diagram showing the touch module and the linear actuator of FIG. 2A. Referring to FIG. 2B, the non-rotary actuator 23 may connect with the touch module 22, the touch panel 221, the display module 222, the frame body 223, or the casing 21. That is, in some aspects, the non-rotary actuator 23 connects with the touch module 22; in some aspects, the non-rotary actuator 23 connects with the touch panel 221; in some aspects, the non-rotary actuator 23 connects with the display module 222; in some aspects, the non-rotary actuator 23 connects with the frame body 223; in some aspects, the non-rotary actuator 23 connects with the casing 21. In this embodiment, the non-rotary actuator 23 connects with the touch module 22 through a frame F for example. The non-rotary actuator 23 and the touch module 22 can be connected by screwing, engaging, or adhering. In this embodiment, the non-rotary actuator 23 is engaged to the frame F for example. Of course, the above-mentioned connecting methods can be applied to connect the non-rotary actuator 23 and the touch module 22, the non-rotary actuator 23 and the touch panel 221, the non-rotary actuator 23 and the display module 222, and the non-rotary actuator 23 and the casing 21.

The non-rotary actuator 23 can be a linear actuator such as a voice coil motor (VCM). The voice coil motor is a kind of linear actuator and is composed of a permanent magnet and a field magnet winding, and it has the properties of direct driving and constant stroke.

To be specified, FIG. 2A only shows one non-rotary actuator 23, but in practice, the touch apparatus 2 may include a plurality of non-rotary actuators 23, which are connected to different parts of the touch module 22.

FIG. 2C is a schematic enlarged diagram of the connection between the touch module 22 and the casing 21 of FIG. 2A. As shown in FIG. 2C, the touch apparatus 2 may further include a buffer supporting unit 24, which connects the touch module 22 to the casing 21. In this case, the frame body 223 of the touch module 22 is connected with the casing 21 through the buffer supporting unit 24. The buffer supporting unit 24 includes a support element 241 and a buffer element 242. The support element 241 passes through the buffer element 242 and connects the frame body 223 to the casing 21. To be noted, FIG. 2A only shows one buffer supporting unit 24, but in practice, the touch apparatus 2 may include a plurality of buffer supporting units 24, which are disposed at different positions in the touch apparatus 2.

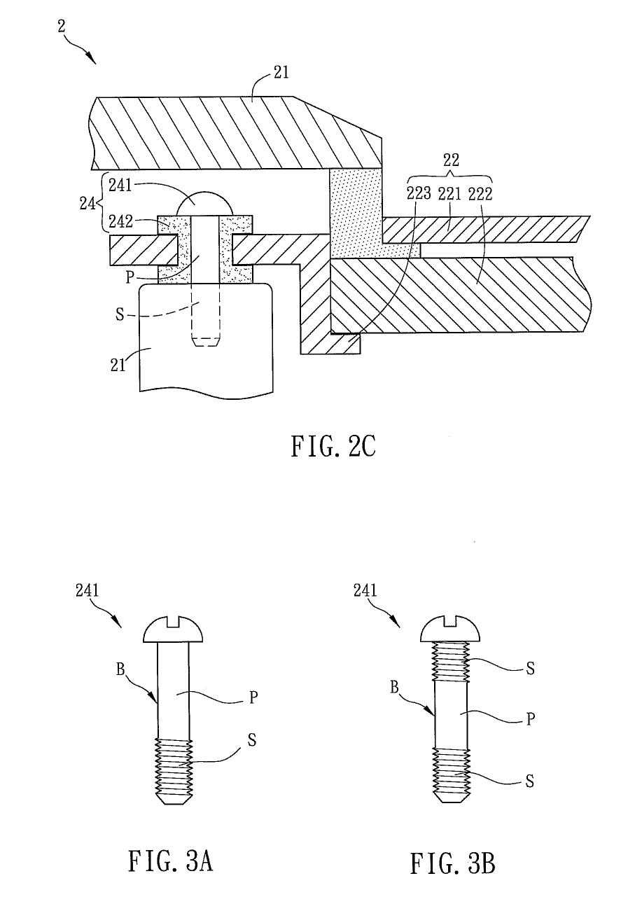

The structure of the support element 241 will be illustrated with reference to FIGS. 3A and 3B. The support element 241 can be a screw, and only a part of the body B of the screw is configured with the screw thread. As shown in FIG. 3A, the body B of the support element 241 is composed of at least a screw-thread portion S and at least a non-screw-thread portion P. Alternatively, as shown in FIG. 3B, the body B of the support element 241 is composed of two screw-thread portions S and a non-screw-thread portion P, which is located between the screw-thread portions S.

Referring to FIG. 2C, the support element 241 is a screw as shown in FIG. 3A. The buffer element 242 is disposed around the non-screw-thread portion P, and the length of the non-screw-thread portion P is greater than the thickness of the casing 21. In this invention, the buffer element 242 can be a rubber washer or a spring, and it is a rubber washer in this embodiment for example. Herein, the support element 241 passes through the buffer element 242, and the screw-thread portion S of the support element 241 is fixed on the casing 21. This can provide the force for fixing the frame body 223 of the touch module 22 to the casing 21. In addition, the buffer element 242 is connected with the non-screw-thread portion P of the support element 241, so that it can be slightly constricted as the screw-thread portion S of the support element 241 is fixed to the casing 21. Thus, according to the function of the buffer element 242, the touch module 22 can have a vertical freedom for vibration, so the vibration feedback can be achieved and the touch module 22 can be protected from damage by the vibration. In this embodiment, the support element 241 and the buffer element 242 can connect the frame body 223 of the touch module 22 to the casing 21.

In addition, the touch apparatus 2 may further include a control circuit (not shown), which is electrically connected with the touch panel 221, the display panel 222 and the non-rotary actuator 23. Accordingly, when the user touches the touch panel 221 of the touch module 22, the control circuit can receive a touch signal outputted from the touch panel 221 and then output a driving signal to the non-rotary actuator 23 for driving the non-rotary actuator 23 to operate (e.g. to vibrate). Thus, the touch module 22, which connects with the non-rotary actuator 23, can be vibrated by the non-rotary actuator 23. Therefore, when a user operates the touch module 22, the touch apparatus 2 can provide a good tactile feedback to the user. Besides, the control circuit can control the non-rotary actuator 23 to operate according to the waveform, cycle, frequency and amplitude of the driving signal. The tactile feedback of the simulated vibration can be achieved by various designs and driving signal. In addition, the control circuit may not receive the signal from the touch module 22 and directly drive the non-rotary actuator 23 to operate.

Moreover, the driving signal may include voice information, which is generated based on the touch signal. For example, when the user clicks an icon, the driving signal is generated to drive the non-rotary actuator 23 to vibrate the touch module 22, the touch panel 221, the display panel 222, the frame body 223, or the casing 21. The vibration of the touch module 22, the touch panel 221, the display panel 222, the frame body 223, or the casing 21 can generate a “Bee” sound so as to achieve the desired sound feedback. Alternatively, the voice information may be not related to the touch signal. For example, the voice information of the communication can be pronounced by generating the driving signal to drive the non-rotary actuator 23 to vibrate the voice membrane such as the touch module 22, the touch panel 221, the display panel 222, the frame body 223, or the casing 21. Since the area of the touch module 22, the touch panel 221, the display panel 222, the frame body 223, or the casing 21 is sufficiently greater than that of the independent voice membrane of the prior art, the present invention has the advantages of clearer sound and longer transmission distance.

As mentioned above, the touch apparatus 2 can provide a good tactile feedback and a good sound feedback. Thus, when the user operates the touch apparatus 2, he/she can enjoy the effects of good tactile and sound feedbacks.

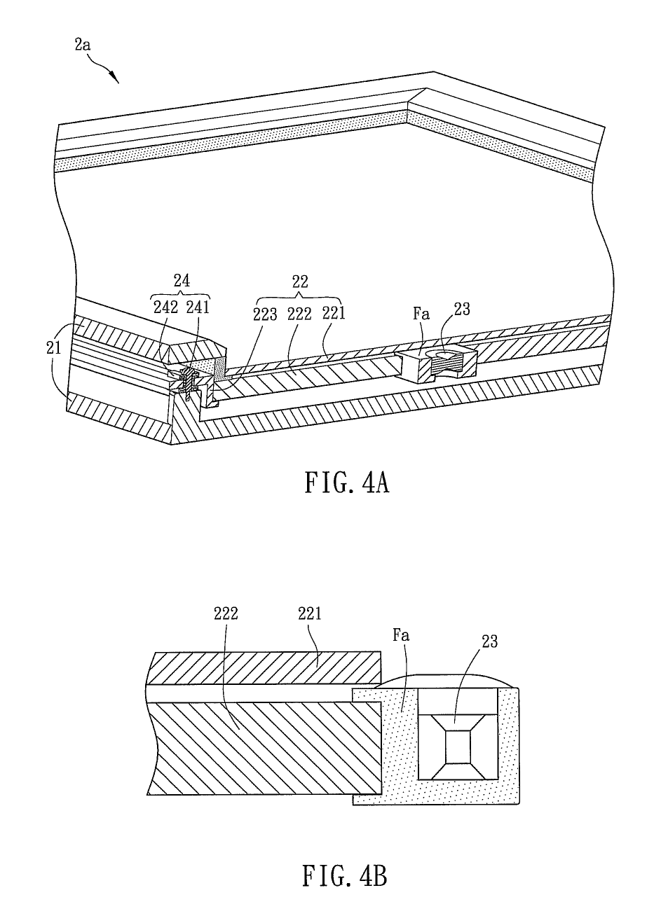

FIG. 4A is a schematic diagram showing the cross-section of a touch apparatus 2a of another aspect according to the preferred embodiment of the present invention, and FIG. 4B is a schematic diagram showing the connection between the touch panel 222 of the touch module 22 and the non-rotary actuator 23 of FIG. 4A. With reference to FIGS. 4A and 4B, the touch apparatus 2a is different from the above-mentioned touch apparatus 2 in that the non-rotary actuator 23 of the touch apparatus 2a is connected with the display panel 222 of the touch module 22 through a frame Fa. When the user operates the touch apparatus 2a, the control circuit can output a driving signal to control the non-rotary actuator 23 to operate so as to vibrate the display panel 222 of the touch module 22. Accordingly, when the user operates the touch apparatus 2a, he/she can also obtain good tactile and sound feedbacks.

The technical features of other components of the touch apparatus 2a are the same as those of the above-mentioned touch apparatus 2, so the detailed descriptions thereof will be omitted.

In brief, the touch apparatus of the invention has the non-rotary actuator, which is connected with the touch module, the touch panel, the display panel, the frame body, or the casing. When the user incurs a touch event on the touch module to drive the non-rotary actuator to operate, the touch module, the touch panel, the display panel, the frame body, or the casing, which is connected with the non-rotary actuator, is moved accordingly. Thus, the good tactile feedback can be provided. In addition, the non-rotary actuator can also vibrate the touch module, the touch panel, the display panel, the frame body, or the casing, which serves as a vibration membrane to make sound. In summary, the touch apparatus of the present invention can provide a good tactile feedback and make sound. To be noted, the present invention uses the casing or the touch module as the vibration membrane for making sound, which is different from the general individual speaker, so the sound holes of the casing are not necessary. Without configuring these sound holes, the touch apparatus of the present invention can provide a better water-proof property.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A touch apparatus comprising:
a casing;
a touch module disposed in the casing and having at least a touch panel; and
at least a non-rotary actuator connected with the casing or the touch module.

2. The touch apparatus according to claim 1, further comprising:
at least a buffer supporting unit for connecting the touch module to the casing.

3. The touch apparatus according to claim 2, wherein the buffer supporting unit comprises a support element and a buffer element, the support element comprises at least a screw-thread portion and at least a non-screw-thread portion, and the buffer element is disposed around the non-screw-thread portion.

4. The touch apparatus according to claim 3, wherein the length of the non-screw-thread portion is greater than the thickness of the casing.

5. The touch apparatus according to claim 1, wherein the non-rotary actuator is a voice coil motor, which comprises a permanent magnet and a field-magnet winding.

6. The touch apparatus according to claim 1, further comprising a control circuit, wherein the control circuit is electrically connected with the non-rotary actuator and outputting a driving signal to control the operation of the non-rotary actuator; or the control circuit is receiving a touch signal outputted from the touch panel and outputting a driving signal.

7. The touch apparatus according to claim 6, wherein the non-rotary actuator operates according to the waveform, cycle, frequency and amplitude of the driving signal.

8. The touch apparatus according to claim 6, wherein the driving signal comprises sound information.

9. The touch apparatus according to claim 6, wherein the touch module further comprises at least one display panel and a frame body, and the touch panel and the display panel are disposed in the frame body.

10. The touch apparatus according to claim 9, wherein the non-rotary actuator is connected with the display panel through a frame, wherein the control circuit controls the non-rotary actuator to operate so as to cause a vibration of the display panel.

11. A touch apparatus comprising:
a casing;
a touch module disposed in the casing and having at least a touch panel, at least a display panel, and a frame body, wherein the touch panel and the display panel are disposed in the frame body, and the frame body is connected with the casing; and
at least a non-rotary actuator connected with the touch panel, the display panel or the frame body.

12. The touch apparatus according to claim 11, further comprising:
at least a buffer supporting unit for connecting the touch module to the casing or connecting the touch panel to the frame body.

13. The touch apparatus according to claim 12, wherein the buffer supporting unit comprises a support element and a buffer element, the support element comprises at least a screw-thread portion and at least a non-screw-thread portion, and the buffer element is disposed around the non-screw-thread portion.

14. The touch apparatus according to claim 13, wherein the length of the non-screw-thread portion is greater than the thickness of the casing.

15. The touch apparatus according to claim 11, wherein the non-rotary actuator is a voice coil motor, which comprises a permanent magnet and a field-magnet winding.

16. The touch apparatus according to claim 11, further comprising a control circuit, wherein the control circuit is electrically connected with the non-rotary actuator and outputting a driving signal to control the operation of the non-rotary actuator; or the control circuit is receiving a touch signal outputted from the touch panel and outputting a driving signal.

17. The touch apparatus according to claim 16, wherein the non-rotary actuator operates according to the waveform, cycle, frequency and amplitude of the driving signal.

18. The touch apparatus according to claim 16, wherein the driving signal comprises sound information.

19. The touch apparatus according to claim 16, wherein the touch module further comprises at least one display panel and a frame body, and the touch panel and the display panel are disposed in the frame body.

20. The touch apparatus according to claim 19, wherein the non-rotary actuator is connected with the display panel through a frame, wherein the control circuit controls the non-rotary actuator to operate so as to cause a vibration of the display panel.
